(19) United States
(12) Patent Application Publication
(10) Pub. No.: US 2025/0097900 A1
(43) Pub. Date: Mar. 20, 2025

(54) SDT HANDLING WITH CELL DTX/DRX ENABLED

(71) Applicant: Nokia Technologies Oy, Espoo (FI)

(72) Inventors: Ahlem KHLASS, Massy (FR); Mads LAURIDSEN, Aalborg (DK)

(21) Appl. No.: 18/829,808

(22) Filed: Sep. 10, 2024

(30) Foreign Application Priority Data
Sep. 15, 2023 (GB) 2314093.2

(51) Int. Cl. H04W 68/02; H04W 52/02; H04W 74/0833; H04W 76/28

(52) U.S. Cl. CPC H04W 68/02; H04W 52/0229; H04W 74/0833; H04W 76/28

(57) ABSTRACT

A method, apparatus, and computer program product are provided for enhancement on cell discontinuous transmission (DTX) operation and discontinuous reception (DRX) operation. In the context of a method, the method includes receiving, from a network node, paging information which contains cell discontinuous operation information, wherein the paging information indicates to the user equipment when to transmit a response message based on the cell discontinuous operation information. The method further includes transmitting, to the network node, the response message using a small data transmission (SDT) procedure based at least on the paging information.

### TECHNOLOGICAL FIELD

An example embodiment relates generally to small data transmission handling and, more particularly, small data transmission handling when cell discontinuous transmission or reception is enabled.

### BACKGROUND

A cell may operate with discontinuous reception and/or discontinuous transmission in order to save energy. Operating with discontinuous reception allows a cell to turn off, partially or completely, reception for user data traffic, control signaling, and reference signals during discontinuous reception non-active periods. Conversely, operating with discontinuous transmission allows a cell to turn off, partially or completely, transmission for user data traffic, control signaling, and reference signals during discontinuous transmission non-active periods.

User equipment devices may be operating in a radio resource control inactive mode or a radio resource control idle mode. In this situation, the user equipment may receive a paging message with a mobile terminated small data transmission indication. In some circumstances, the paging message is a one bit indication. Upon receiving the paging message, the user equipment may respond by performing random access based small data transmission or configured grant small data transmission, including initial downlink data reception and subsequent uplink and downlink data transmissions in radio resource control inactive mode or radio resource control idle mode.

A cell's pattern of discontinuous reception and/or discontinuous transmission may be based on a pattern configuration which is provided to radio resource control connected user equipment devices through dedicated radio resource control signaling. In some situations, a cell may have separate discontinuous transmission and discontinuous reception configurations. A dynamic de-activation indication may be provided through L1 signaling. However, user equipment devices in a radio resource control inactive mode or a radio resource control idle mode are not aware of the cell's pattern (de)-activation or L1 monitoring occasions. Upon receiving a paging message with a mobile terminated small data transmission indication, the radio resource control inactive suer equipment may start mobile terminated small data transmission while the network is in a discontinuous reception non-active period. In this situation, the cell does not receive the user equipment's response to paging.

### BRIEF SUMMARY

In one or more embodiments, a user equipment (110) is provided, including at least one processor and at least one memory storing instructions that, when executed by the processor, cause the user equipment to receive (340), from a network node (120), paging information (340A) which contains cell discontinuous operation information (340B), wherein the paging information (340A) indicates to the user equipment (110) when to transmit a response message (350A) based on the cell discontinuous operation information. The user equipment (110) is further caused to transmit (350), to the network node (120), the response message (350A) using a small data transmission (SDT) procedure (350B) based at least on the paging information (340A).

In one or more embodiments, a network node (120) is provided, including at least one processor and at least one memory storing instructions that, when executed by the processor, cause the network node (120) to transmit (340), to a user equipment (110), paging information (340A) which contains cell discontinuous operation information (340B), wherein the paging information (340A) indicates to the user equipment (110) when to transmit a response message (350A) based on the cell discontinuous operation information. The network node (120) is further caused to receive (350), from the user equipment (110), the response message (350A) based at least on the paging information (340A).

In one or more embodiments, a computer-implemented method is provided that is performed by a user equipment (110) and includes receiving (340), from a network node (120), paging information (340A) which contains cell discontinuous operation information (340B), wherein the paging information (340A) indicates to the user equipment (110) when to transmit a response message (350A) based on the cell discontinuous operation information. The method further includes transmitting (350), to the network node (120), the response message (350A) using a small data transmission (SDT) procedure (350B) based at least on the paging information (340A).

In one or more embodiments, a computer implemented method is provided that is performed by a network node (120) and includes transmitting (340), to a user equipment (110), paging information (340A) which contains cell discontinuous operation information (340B), wherein the paging information (340A) indicates to the user equipment (110) when to transmit a response message (350A) based on the cell discontinuous operation information. The computer-implemented method further includes receiving (350), from the user equipment (110), the response message (350A) based at least on the paging information (340A).

In one or more embodiments, a non-transitory computer readable storage medium is provided including computer instructions that, when executed by a user equipment (110), cause the user equipment (110) to receive (340), from a network node (120), paging information (340A) which contains cell discontinuous operation information (340B), wherein the paging information (340A) indicates to the user equipment (110) when to transmit a response message (350A) based on the cell discontinuous operation information. The user equipment (110) is further caused to transmit (350), to the network node (120), the response message (350A) using a small data transmission (SDT) procedure (350B) based at least on the paging information (340A).

In one or more embodiments, a non-transitory computer readable storage medium is provided including computer instructions that, when executed by a network node (120), cause the network node (120) to transmit (340), to a user equipment (110), paging information (340A) which contains cell discontinuous operation information (340B), wherein the paging information (340A) indicates to the user equipment (110) when to transmit a response message (350A) based on the cell discontinuous operation information. The network node (120) is further caused to receive (350), from the user equipment (110), the response message (350A) based at least on the paging information (340A).

In one or more embodiments, a user equipment (110) is provided that includes means for receiving (340), from a network node (120), paging information (340A) which contains cell discontinuous operation information (340B), wherein the paging information (340A) indicates to the user equipment (110) when to transmit a response message (350A) based on the cell discontinuous operation information. The user equipment (110) further includes means for transmitting (350), to the network node (120), the response message (350A) using a small data transmission (SDT) procedure (350B) based at least on the paging information (340A).

In one or more embodiments, a network node (120) is provided that includes means for transmitting (340), to a user equipment (110), paging information (340A) which contains cell discontinuous operation information (340B), wherein the paging information (340A) indicates to the user equipment (110) when to transmit a response message (350A) based on the cell discontinuous operation information. The network node (120) further includes means for receiving (350), from the user equipment (110), the response message (350A) based at least on the paging information (340A).

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 is a block diagram of a system including both a user equipment and a network node configured to communicate at least via uplink and downlink transmission in accordance with an example embodiment of the present disclosure;

FIG. 2 is a block diagram of an example communication system in which the system of FIG. 1 may be deployed in accordance with an example embodiment of the present disclosure;

FIG. 3 is a flow diagram illustrating a situation where the network node signals an active cell discontinuous reception/transmission pattern identifier to the user equipment in accordance with an example embodiment of the present disclosure;

FIG. 4 is a flow diagram illustrating a situation where the network node signals a cell discontinuous reception/transmission timer to the user equipment in accordance with an example embodiment of the present disclosure;

FIG. 5 is a paging message indicating cell discontinuous reception/transmission information in accordance with an example embodiment of the present disclosure;

FIG. 6 is a paging early indication indicating cell discontinuous reception/transmission information in accordance with an example embodiment of the present disclosure;

FIG. 7 is a flowchart illustrating operations performed by a user equipment in accordance with an example embodiment of the present disclosure; and

FIG. 8 is a flowchart illustrating operations performed by a network node in accordance with an example embodiment of the present disclosure.

### DETAILED DESCRIPTION

Some embodiments of the present disclosure will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present disclosure. Thus, use of any such terms should not be taken to limit the spirit and scope of embodiments of the present disclosure.

Additionally, as used herein, the term “circuitry” refers to (a) hardware-only circuit implementations (e.g., implementations in analog circuitry and/or digital circuitry); (b) combinations of circuits and computer program product(s) including software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, as used herein, the term “circuitry” also includes an implementation including one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

As used herein, the term “computer-readable medium” refers to non-transitory storage hardware, non-transitory storage device or non-transitory computer system memory that may be accessed by a controller, a microcontroller, a computational system or a module of a computational system to encored thereon computer-executable instructions or software programs. A non-transitory “computer readable medium” may be accessed by a computational system or a module of a computational system to retrieve and/or execute the computer-executable instructions or software programs encoded on the medium. Examples of non-transitory computer-readable media may include, but are not limited to, one or more types of hardware memory, non-transitory tangible media (for example, one or more magnetic storage disks, one or more optical disks, one or more universal synchronous bus (USB) flash drives), computer system memory or random-access memory (such as dynamic random access memory (DRAM), static random access memory (SRAM), extended data out random access memory (EDO RAM), and the like.

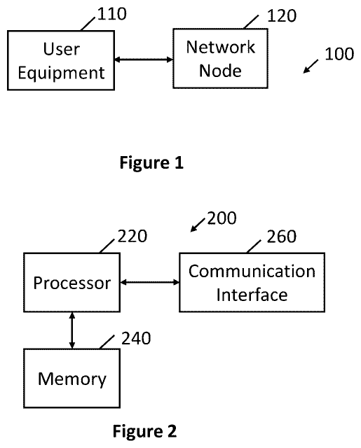

As illustrated in FIG. 1, a system 100 is provided in accordance with an example embodiment in order to handle small data transmission procedures when a cell is in discontinuous reception or transmission mode. Although the system may be configured in various manners, the system of one embodiment is depicted in FIG. 1 and includes user equipment 110 and network node 120 configured to communicate via uplink and downlink transmission and reception beams. Although one user equipment and one network node is depicted, the system may include and the user equipment 110 and network node 120 may communicate with additional user equipment and network node in other embodiments. In one or more embodiments, the user equipment 110 and network node 120 may configured to support, for example, 5G, 5G advanced, or 6G. In one or more embodiments, the system 100 may support carrier aggregation and/or dual connectivity. As described below, the system may support paging triggered small data transmission, such as mobile terminated small data transmission and/or mobile originated small data transmission.

The data that is transmitted via the uplink and downlink beams between the user equipment 110 and the network node 120 may be any of a wide variety of data including, but not limited to digital imagery data including video data, audio data as well as data provided by sensors, radars, telescopes and radio receivers. In at least some instances, the data is encoded prior to communication of the data via the uplink and downlink beams and decoded upon reception. The resulting data received may be utilized for a variety of purposes including presentation to a user, storage of the data for subsequent use and/or provision of the data to one or more applications, such as applications that perform statistical inference on the data for various purposes including object recognition, image classification, spectrum sensing, speech transcription and/or prediction or detection of events.

The user equipment 110 of FIG. 1 (also called UE, user device, user terminal, terminal device, etc.) illustrates a type of an apparatus which resources on an air interface are allocated and assigned. The user equipment 110 typically refers to a portable computing device that includes wireless mobile communication devices operating with or without a subscriber identification module (SIM), including, but not limited to, the following types of devices: a mobile station (mobile phone), smartphone, personal digital assistance (PDA), handset, device using a wireless modem (alarm or measurement device, etc.), laptop and/or touch screen computer, tablet, game console, notebook, and multimedia device. User equipment 110 may also be a device having capability to operate in Internet of Things (IoT) network which is a scenario in which objects are provided with the ability to transfer data over a network without requiring human-to-human or human-to-computer interaction. The user equipment 110 may also be called a subscriber unit, mobile station, remote terminal, access terminal, user terminal, or user equipment (UE) just to mention but a few names or apparatuses. The user equipment 110 may be connected via radio resource control. The user equipment may be in a radio resource control inactive mode or a radio resource control idle mode.

The network node 120 of FIG. 1 may include, for example, base stations such as remote radio heads (RRHs), transmission reception points (TRPs), access points, node Bs (e.g., gNB) or other transmission sources. The network node 120 may be configured to communicate with user equipment 110 via a network. The network node 120 may have active periods of reception and/or transmission and inactive periods of reception and/or transmission. The network node may operate with discontinuous reception and/or transmission in a cell.

FIG. 2 depicts an example apparatus 200 that may be configured to function as user equipment 110 or network node 120. As shown in FIG. 2, the apparatus includes, is associated with, or is in communications with processing circuitry 220, a memory 240, and a communication interface 260. The processing circuitry 220 may be in communication with the memory device 240 via a bus for passing information among components of the apparatus. The memory device may be non-transitory and may include, for example, one or more volatile and/or non-volatile memories. In other words, for example, the memory device may be an electronic storage device (e.g., a computer readable storage medium) including gates configured to store data (e.g., bits) that may be retrievable by a machine (e.g., a computing device like the processing circuitry). The memory device may be configured to store information, data, content, applications, instructions, or the like for enabling the apparatus to carry out various functions in accordance with an example embodiment of the present disclosure. For example, the memory device could be configured to buffer input data for processing by the processing circuitry. Additionally or alternatively, the memory device could be configured to store instructions for execution by the processing circuitry.

The apparatus 200 may, in some embodiments, be embodied in various computing devices described as above. However, in some embodiments, the apparatus may be embodied as a chip or chip set. In other words, the apparatus may include one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment on a single chip or as a single “system on a chip.” As such, in some cases, a chip or chipset may constitute means for performing one or more operations for providing the functionalities described herein.

The processing circuitry 220, also referenced as a processor, may be embodied in a number of different ways. For example, the processing circuitry may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining, and/or multithreading.

In an example embodiment, the processing circuitry 220 may be configured to execute instructions stored in the memory device 240 or otherwise accessible to the processing circuitry. Alternatively or additionally, the processing circuitry may be configured to execute hardcoded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processing circuitry is embodied as an executor of instructions, the instructions may specifically configure the processor to perform the algorithms and/or operations described herein when the instructions are executed. However, in some cases, the processing circuitry may be a processor of a specific device (e.g., an image or video processing system) configured to employ an embodiment by further configuration of the processing circuitry by instructions for performing the algorithms and/or operations described herein. The processing circuitry may include, among other things, a clock, an arithmetic logic unit (ALU) and logic gates configured to support operation of the processing circuitry.

The communication interface 260 may be any means such as a device or circuitry embodied in either hardware or a combination of hardware and software that is configured to receive and/or transmit data including media content in the form of video or image files, one or more audio tracks or the like. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communications interface may alternatively or also support wired communication. As such, for example, the communication interface may include a communication modem and/or other hardware/software for supporting communication via cable, digital subscriber line (DSL), universal serial bus (USB) or other mechanisms.

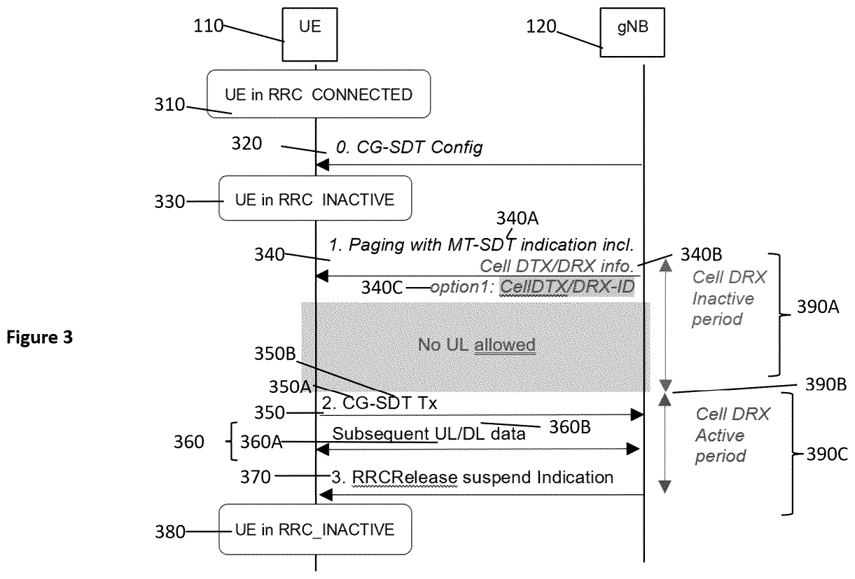

Turning now to FIG. 3, a flow diagram is provided illustrating a situation where the network node signals an active cell discontinuous reception/transmission pattern identifier to the user equipment in accordance with an example embodiment of the present disclosure.

In one or more embodiments, at operation 310, the user equipment 110 is connected via radio resource control. In one or more embodiments, user equipment 110 is able to receive information from network node 120 via dedicated radio resource control signaling.

In one or more embodiments, at operation 320, user equipment 110 receives a configured grant small data transmission configuration from network node 120. In one or more embodiments, the configurated grant small data transmission configuration is received via dedicated radio resource control signaling. In one or more embodiments, the configured grant small data transmission configuration configures the user equipment to transmit a response message via configured grant small data transmission in response to mobile terminated small data transmission paging.

In one or more embodiments, at operation 330, user equipment 110 enters into a radio resource control (RRC) inactive mode. In one or more alternative embodiments, user equipment 110 enters into a radio resource control idle mode. In one or more embodiments, the radio resource control connection 310 is released or suspended.

In one or more embodiments, at operation 340, the user equipment 110 receives paging information 340A from the network node 120. In one or more embodiments, the network node 120 is an anchor network node that previously configured the user equipment 110 with cell discontinuous operation pattern identifiers. In one or more embodiments, the paging information 340A is one of a paging message, a paging early indication, a wake-up signal, or a paging downlink control information. In one or more embodiments, the paging information 340A includes a mobile terminated small data transmission (SDT) indication. For example, the paging information 340A may indicate when the user equipment 110 should transmit a response message 350A. In one or more embodiments, the paging information 340A includes cell discontinuous operation information 340B. In one or more embodiments, the cell discontinuous operation information 340B indicates at least one of a discontinuous reception operation or a discontinuous transmission operation. In one or more embodiments, the cell discontinuous operation information includes an active cell discontinuous operation pattern identifier 340C. For example, user equipment 110 may have previously received and stored multiple cell discontinuous operation patterns with associated cell discontinuous operation pattern identifiers before entering into a radio resource control inactive mode 330. In one or more embodiments, the active cell discontinuous operation pattern identifier 340C indicates one of the previously received and stored cell discontinuous operation pattern identifiers. In one or more embodiments, the cell discontinuous operation information includes information defining a cell discontinuous operation pattern including at least one of a periodicity, an active period, and a starting offset.

In one or more alternative embodiments, the network node 120 broadcasts a cell discontinuous operation pattern. In one or more embodiments, the cell discontinuous operation pattern is configured via system information broadcast or radio resource control. In one or more embodiments, the cell discontinuous operation pattern is a discontinuous reception (DRX) pattern or a discontinuous transmission (DTX) pattern. In one or more embodiments, the activation status of the pattern is not received through paging. In one or more embodiments, the cell discontinuous operation pattern includes at least one of a periodicity, an active period, and a starting offset.

In one or more embodiments, the active cell discontinuous operation pattern identifier 340C indicates a cell discontinuous reception inactive period 390A and a cell discontinuous reception active period 390C. In one or more embodiments, the user equipment 110 does not transmit a response message during the cell discontinuous reception inactive period 390A. In one or more embodiments, the user equipment 110 waits until the start 390B of a next cell discontinuous reception active period 390C of the activated cell discontinuous operation pattern to transmit a response message.

In one or more embodiments, at operation 350, the user equipment 110 transmits a response message 350A after start 390B of the next cell discontinuous reception active period 390C. In one or more embodiments, the user equipment 110 transmits the response message 350A using a small data transmission (SDT) procedure 350B based on the paging information 340A. In one or more embodiments, the response message may be a configured grant small data transmission. In one or more alternative embodiments, the user equipment performs a random access based small data transmission. In one or more embodiments, the response message 350A may use a mobile terminated small data transmission, a mobile originated small data transmission, a subsequent uplink transmission, or a subsequent downlink transmission. In one or more embodiments, user equipment 110 may monitor other paging frames and paging occasions before mobile originated small data transmission initiation in order to detect paging information that may contain cell discontinuous operation information. In one or more embodiments, the user equipment 110 monitors for a limited time period prior to initiating subsequent uplink transmission or mobile originated small data transmission in order to avoid excess user equipment power consumption from physical downlink control channel monitoring.

In one or more embodiments, at operation 360, the user equipment 110 performs a subsequent uplink transmission to network node 120. In one or more alternative embodiments, network node 120 performs a subsequent downlink transmission to user equipment 110.

In one or more embodiments, at operation 370, network node 120 transmits, to user equipment 110, a radio resource control release suspend indication. In one or more embodiments, user equipment 110 suspends or releases any radio resource control connectivity.

In one or more embodiments, user equipment 110 returns to a radio resource control inactive mode at operation 380 based at least on the radio resource control release suspend indication received in operation 370.

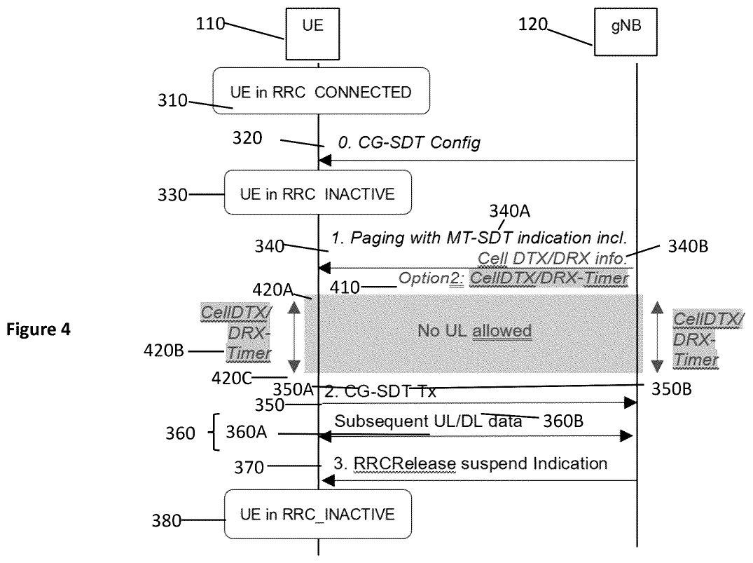

Turning now to FIG. 4, a flow diagram is provided illustrating a situation where the network node signals a cell discontinuous reception/transmission timer to the user equipment in accordance with an example embodiment of the present disclosure.

In one or more embodiments, at operation 310, the user equipment 110 is connected via radio resource control. In one or more embodiments, user equipment 110 is able to receive information from network node 120 via dedicated radio resource control signaling.

In one or more embodiments, at operation 320, user equipment 110 receives a configured grant small data transmission configuration from network node 120. In one or more embodiments, the configurated grant small data transmission configuration is received via dedicated radio resource control signaling. In one or more embodiments, the configured grant small data transmission configuration configures the user equipment to transmit a response message via configured grant small data transmission in response to mobile terminated small data transmission paging.

In one or more embodiments, at operation 330, user equipment 110 enters into a radio resource control inactive mode. In one or more alternative embodiments, user equipment 110 enters into a radio resource control idle mode. In one or more embodiments, the radio resource control connection 310 is released or suspended.

In one or more embodiments, at operation 340, the user equipment 110 receives paging information 340A from the network node 120. In one or more embodiments, the network node 120 is an anchor network node previously connected to the user equipment 110 or a network node which the user equipment 110 moved into while in radio resource control idle mode or radio resource control inactive mode. In one or more embodiments, the paging information 340A is a paging message, a paging early indication, a wake-up signal, or a paging downlink control information. In one or more embodiments, the paging information 340A includes a mobile terminated small data transmission indication. For example, the paging information 340A may indicate when the user equipment 110 should transmit a response message 350A. In one or more embodiments, the paging information 340A includes cell discontinuous operation information 340B. In one or more embodiments, the cell discontinuous operation information 340B indicates at least one of a discontinuous reception operation or a discontinuous transmission operation. In one or more embodiments, the cell discontinuous operation information includes a cell discontinuous operation timer 410 corresponding to a current time period 420B, which begins at time 420A and defines the cell is in discontinuous operation during this period which means the cell may be unable to receive and/or transmit. In one or more embodiments, the cell discontinuous operation timer 410 is referenced to a start time when the paging information is received or a configured reference time. In one or more embodiments, the user equipment 120 delays transmission of a response message 350A until the end 420C of the current time period 420B. In one or more embodiments, the timer is applied after reception of the paging information 340A and given in a value of ms or number of slots. In one or more embodiments, the cell discontinuous operation timer 410 is cell-based and commonly configured for all user equipment devices in a cell. In one or more embodiments, the cell discontinuous operation timer 410 is specific to user equipment 110. In one or more embodiments, the cell discontinuous operation timer 410 is determined based on an offset value provided for the user equipment 110. In one or more embodiments, the offset value is pre-configured for the user equipment 110. In one or more embodiments, the offset value is multiplied by a random value from a range of pre-configured values. In one or more embodiments, the value of the cell discontinuous operation timer 410 is indicated by the use of a bitmap (i.e., an index in the paging information 340A may be used to determine a timer value according to a table in, for example, a specification, system information broadcast, cell discontinuous transmission configuration, cell discontinuous reception configuration, or the like).

In one or more embodiments, the user equipment 110 does not initiate configured grant based small data transmission 350 or random access-based small data transmission until the end 420C of the current time period 420B. In one or more embodiments, specific conditions may be defined to stop the cell discontinuous operation timer 410 and perform access based small data transmission or a random access procedure on specific random access resources during the current time period 420B. For example the specific condition may be an emergency call or emergency/alert/warning services. In one or more embodiments, the paging information 340A may indicate a time duration in which the user equipment 110 may transmit a response message after the end 420C of the current time period 420B. This time duration may correspond to the cell discontinuous operation active time, where the cell is able to receive and/transmit.

In one or more alternative embodiments, user equipment 110 may transmit a response message before the end 420C of the current time period 420B. In these example embodiments, the current time period 420B corresponds to a cell discontinuous reception active period. In these example embodiments, if a next configured grant occasion falls after the end 420C of the current time period 420B, user equipment 110 uses a random access based small data transmission or random access procedure to transmit a response message, during the current time period 420B, even if configured grant based small data transmission conditions are satisfied, so that the cell receives the response during a cell discontinuous reception active period.

In one or more embodiments, at operation 350, the user equipment 110 transmits a response message 350A. In one or more embodiments, the user equipment 110 transmits the response message 350A using a small data transmission (SDT) procedure 350B based on the paging information 340A. In one or more embodiments, the response message is a configured grant small data transmission. In one or more alternative embodiments, the user equipment performs a random access based small data transmission. In one or more alternative embodiments, the user equipment performs a random access based small data transmission. In one or more embodiments, the response message 350A may use a mobile terminated small data transmission, a mobile originated small data transmission, a subsequent uplink transmission, or a subsequent downlink transmission. In one or more embodiments, user equipment 110 may monitor other paging frames and paging occasions before mobile originated small data transmission or subsequent uplink transmission initiation in order to detect paging information that may contain cell discontinuous operation information. In one or more embodiments, the user equipment 110 monitors for a limited time period prior to initiating subsequent uplink transmission or mobile originated small data transmission in order to avoid excess user equipment energy consumption from physical downlink control channel monitoring.

In one or more embodiments, at operation 360, the user equipment 110 performs a subsequent uplink transmission to network node 120. In one or more alternative embodiments, network node 120 performs a subsequent downlink transmission to user equipment 110.

In one or more embodiments, at operation 370, network node 120 transmits, to user equipment 110, a radio resource control release suspend indication. In one or more embodiments, user equipment 110 suspends or releases any radio resource control connectivity.

In one or more embodiments, user equipment 110 returns to a radio resource control inactive mode at operation 380 based at least on the radio resource control release suspend indication received in operation 370.

Referring to FIGS. 3-4, in one or more embodiment, the paging information 340A may indicate whether to use an active cell discontinuous operation pattern identifier or a cell discontinuous operation timer. In one or more embodiments, the indication is provided as a flag or bit in a paging downlink control information which schedules the paging information. In one or more embodiments, the indication is provided as a flag or bit in the paging information 340A (e.g., in a paging message). In one or more embodiments, if only one of an active cell discontinuous operation pattern identifier 340C or a cell discontinuous operation timer 410 is included in the paging information 340A the user equipment 110 applies the included identifier or timer. In one or more embodiments, the user equipment 110 applies the cell discontinuous operation timer 410 if it is included in the paging information 340A, independently of whether the active cell discontinuous operation pattern identifier 340C is included in the paging information 340A, wherein the user equipment 110 applies the active cell discontinuous operation pattern identifier 340C if a cell discontinuous operation timer 410 is not included in the paging information 340A. In one or more embodiments, the user equipment 110 applies the active cell discontinuous operation pattern identifier 340C if it is included in the paging information 340A, independently of whether the cell discontinuous operation timer 410 is included in the paging information 340A, wherein the user equipment 110 applies the cell discontinuous operation timer 410 if an active cell discontinuous operation pattern identifier 340C is not included in the paging information 340A.

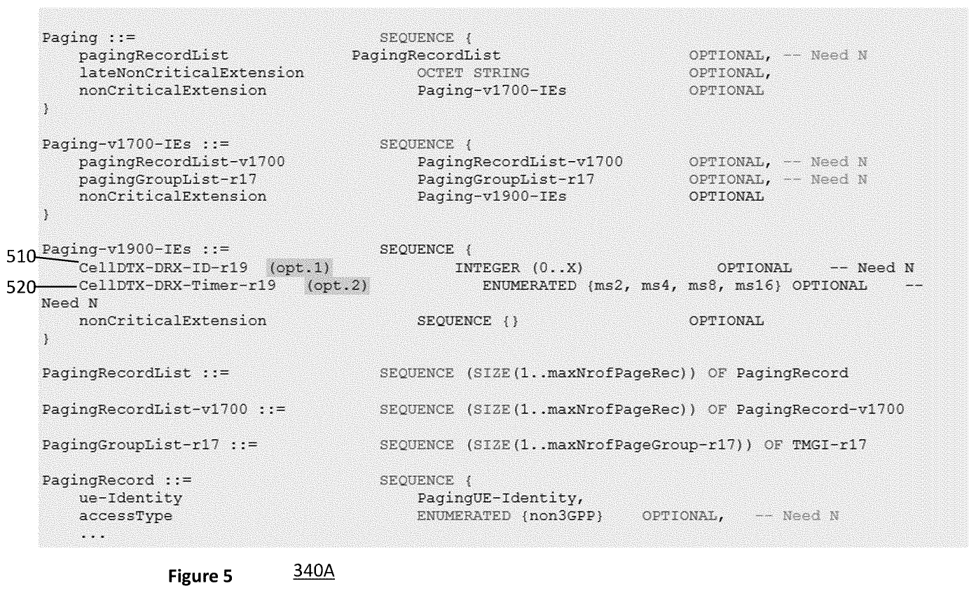

Turning now to FIG. 5, example paging information 340A is provided. In one or more embodiments, paging information 340A is a paging message. In one or more embodiments, the paging message may be received by a user equipment 110. In one or more embodiments, the paging message includes a paging record with a paging identity. In one or more embodiments, the paging message includes a CellDTX-DRX-r19 indication, for example, indications 510 or 520. In one or more embodiments, when indication 510 or 520 is included in the paging message, user equipment 110 assumes that cell discontinuous transmission or cell discontinuous reception is enabled. If a single discontinuous operation pattern is enabled, the indication 510/520 may be a single bit. In one or more embodiments where multiple patterns are configured, the indication indicates which pattern identifier is activated. For example, the indication may be a discontinuous reception pattern, a discontinuous transmission pattern, or a combination pattern of discontinuous reception and discontinuous transmission.

In one or more embodiments, indication 510 describes an active cell discontinuous operation pattern identifier 340C. In one or more embodiments, indication 520 describes a cell discontinuous operation timer 410. In one or more embodiments, indications 510/520 may be included directly in a paging message. In one or more alternative embodiments, indications 510/520 are indexes to a pre-configured table. In one or more alternative embodiments, indication 520 is a flag or bit indicating that the user equipment 110 should apply the cell discontinuous operation timer.

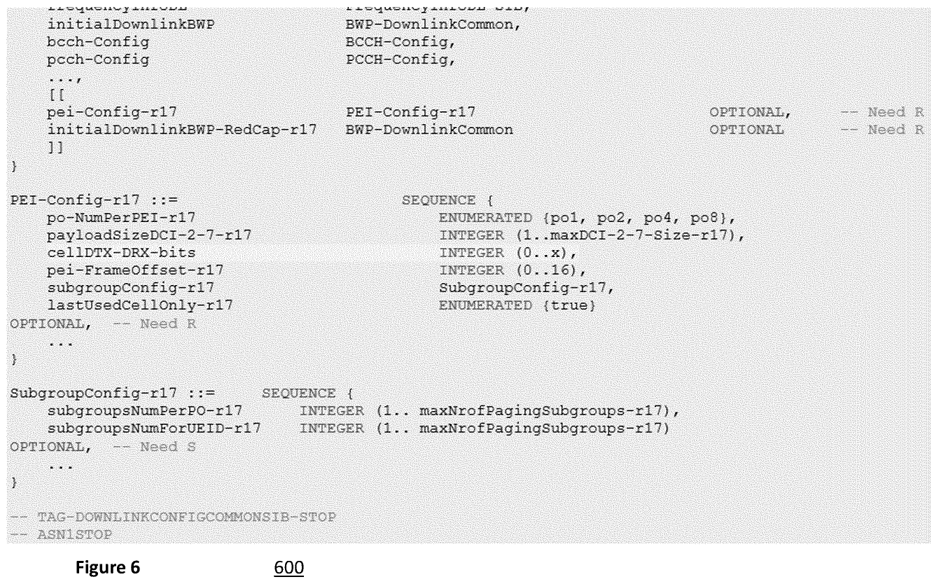

Turning now to FIG. 6, a paging early indication 600 is provided. In one or more embodiments, indication 510/520 is included in a short message of a paging downlink control information which schedules the paging message or in the paging early indication. In one or more embodiments, a paging early indication 600 is a downlink control information transmitted using the physical downlink control channel. In one or more embodiments, indication 610 indicates the number of bits that are used for CellDTX-DRX used for a CellDTX-DRX indication in the paging early indication. In one or more embodiments, the paging early indication configuration is DownlinkConfigCommonSIB.

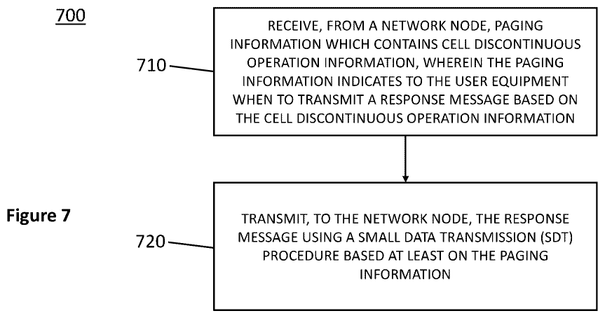

Turning now to FIG. 7, an example flowchart is illustrated for a process 700 performed by an apparatus embodied by, associated with or otherwise in communication with (hereinafter generally referenced as being embodied by) a user equipment 110 in order to transmit a response message using a small data transmission (SDT) procedure based on paging information.

As shown in block 710 of FIG. 7, the apparatus embodied by the user equipment 110 includes means, such as the processing circuitry 220, the communication interface 260, or the like, for receiving (340), from a network node (120), paging information (340A) which contains cell discontinuous operation information (340B), wherein the paging information (340A) indicates to the user equipment (110) when to transmit a response message (350A) based on the cell discontinuous operation information. In one or more embodiments, the paging information (340A) includes at least one of: a paging early indication, a wake-up signal, a paging DCI or a paging message. In one or more embodiments, the user equipment (110) is in a radio resource control idle mode or in a radio resource control inactive mode (330). In one or more embodiments, the cell discontinuous operation information (340B) indicates discontinuous reception (DRX) operation or discontinuous transmission (DTX) operation. In one or more embodiments, the user equipment (110) is configured to monitor first paging information not associated with a paging occasion associated with the user equipment (110) or second paging information (340A) of the paging occasion associated with the user equipment (110) for a second time period prior to initiating the subsequent uplink transmission (360A).

In one or more embodiments, the cell discontinuous operation information (340B) includes at least one of an active cell discontinuous operation pattern identifier (340C), a cell discontinuous operation pattern, or a cell discontinuous operation timer (410) that corresponds to a current time period (420B). In one or more embodiments, the current time period may be commonly configured for all user equipment devices in a particular cell via system information broadcast, specific to the user equipment (110), or indicated by use of a bitmap in the paging information (340A). For example, the cell discontinuous operation timer (410) may be referenced to a start time when the paging information is received or a configured reference time. In some embodiments, the paging information (340A) further indicates whether to use the active cell discontinuous operation pattern identifier (340C) or the cell discontinuous operation timer (410). For example, if only one of the active cell discontinuous operation pattern identifier (340C) or cell discontinuous operation timer (410) is included in the paging information (340A), the user equipment (110) only applies that which is included. As another example, if the user equipment (110) is not aware of any cell discontinuous operation pattern identifiers, the user equipment (110) may apply the cell discontinuous operation timer (410). In some examples, a cell discontinuous operation pattern includes at least one of a periodicity, an active period, and a starting offset. In some examples, the user equipment (110) may obtain the cell discontinuous operation patterns from system information broadcast (SIB) or radio resource control (RRC).

As shown in block 720 of FIG. 7, the apparatus embodied by the user equipment 110 includes means, such as the processing circuitry 220, the communication interface 260, or the like, for transmitting (350), to the network node (120), the response message (350A) using a small data transmission (SDT) procedure (350B) based at least on the paging information (340A). In one or more embodiments, the response message (350A) alternately uses at least one of: a mobile terminated small data transmission, a mobile originated small data transmission, a subsequent uplink transmission (360A), or a subsequent downlink transmission (360B). In examples where the paging information (340A) indicates an active cell discontinuous operation pattern identifier (340C) or a cell discontinuous operation pattern, the user equipment (110) transmits the response message (350A) at the beginning (390B) of a next cell discontinuous reception active period (390C) of the activated cell discontinuous operation pattern. In some examples, the response message (350A) may be a random access preamble or data directly transmitted in pre-configured resources. In examples when the paging information (340A) indicates a cell discontinuous operation timer (410), the user equipment (110) transmits the response message (350A) after an end (420C) of the current time period (420B). In some examples where the paging information (340A) indicates a cell discontinuous operation timer (410), the paging information (340A) further indicates a time duration within which the user equipment (110) transmits the response message (350A) after the end (420C) of the current time period (420B). In other examples where the paging information indicates a cell discontinuous operation timer (410), the paging information (340A) further indicates specific conditions for, prior to the end (420C) of the current time period (420B), performing random access based small data transmission or random access procedure on specific random access resources. For example, the specific conditions may be high priority data/calls (e.g., above a threshold priority) or a certain access class. For example, the specific conditions may describe an emergency.

In some examples, when the paging information (340A) indicates a cell discontinuous operation timer (410), the user equipment (110) transmits the response message (350A) before an end (420C) of the current time period (420B). In some of these examples, when a next configured grant occasion occurs after the end (420C) of the current time period (420B), the user equipment (110) uses a random access based small data transmission or random access procedure to transmit the response message (350A).

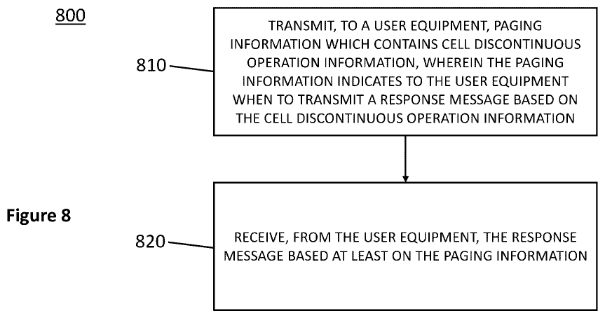

Turning now to FIG. 8, an example flowchart is illustrated for a process 800 performed by an apparatus embodied by, associated with or otherwise in communication with (hereinafter generally referenced as being embodied by) a network node 120 to receive a response message based on paging information.

As shown in block 810 of FIG. 8, the apparatus embodied by the network node 120 includes means, such as the processing circuitry 220, the communication interface 260, or the like, for transmitting (340), to a user equipment (110), paging information (340A) which contains cell discontinuous operation information (340B), wherein the paging information (340A) indicates to the user equipment (110) when to transmit a response message (350A) based on the cell discontinuous operation information. In one or more embodiments, the paging information (340A) includes at least one of: a paging early indication, a wake-up signal, a paging DCI or a paging message. In one or more embodiments, the user equipment (110) is in a radio resource control idle mode or in a radio resource control inactive mode (330). In one or more embodiments, the cell discontinuous operation information (340B) indicates discontinuous reception (DRX) operation or discontinuous transmission (DTX) operation.

In one or more embodiments, the cell discontinuous operation information (340B) includes at least one of an active cell discontinuous operation pattern identifier (340C), a cell discontinuous operation pattern, or a cell discontinuous operation timer (410) that corresponds to a current time period (420B). In one or more embodiments, the current time period may be commonly configured for all user equipment devices in a particular cell via system information broadcast, specific to the user equipment (110), or indicated by use of a bitmap in the paging information (340A). For example, the cell discontinuous operation timer (410) may be referenced to a start time when the paging information is received or a configured reference time. In some embodiments, the paging information (340A) further indicates whether to use the active cell discontinuous operation pattern identifier (340C) or the cell discontinuous operation timer (410). In some examples, a cell discontinuous operation pattern includes at least one of a periodicity, an active period, and a starting offset. In some examples, the user equipment (110) may obtain the cell discontinuous operation patterns from system information broadcast (SIB) or radio resource control (RRC).

As shown in block 820 of FIG. 8, the apparatus embodied by the network node 120 includes means, such as the processing circuitry 220, the communication interface 260, or the like, for receiving (350), from the user equipment (110), the response message (350A) based at least on the paging information (340A). In one or more embodiments, the response message (350A) alternately uses at least one of: a mobile terminated small data transmission, a mobile originated small data transmission, a subsequent uplink transmission (360A), or a subsequent downlink transmission (360B). In examples where the paging information (340A) indicates an active cell discontinuous operation pattern identifier (340C) or a cell discontinuous operation pattern, the network node (120) receives the response message (350A) at the beginning (390B) of a next cell discontinuous reception active period (390C) of the activated cell discontinuous operation pattern. In some examples, the response message (350A) may be a random access preamble or data directly transmitted in pre-configured resources. In examples when the paging information (340A) indicates a cell discontinuous operation timer (410), the network node (120) receives the response message (350A) after an end (420C) of the current time period (420B). In some examples where the paging information (340A) indicates a cell discontinuous operation timer (410), the paging information (340A) further indicates a time duration within which the network node (120) receives the response message (350A) after the end (420C) of the current time period (420B). In other examples where the paging information indicates a cell discontinuous operation timer (410), the paging information (340A) further indicates specific conditions for, prior to the end (420C) of the current time period (420B), performing random access based small data transmission or random access procedure on specific random access resources. For example, the specific conditions may be high priority data/calls (e.g., above a threshold priority) or a certain access class. For example, the specific conditions may describe an emergency.

In some examples, when the paging information (340A) indicates a cell discontinuous operation timer (410), the network node (120) receives the response message (350A) before an end (420C) of the current time period (420B). In some of these examples, when a next configured grant occasion occurs after the end (420C) of the current time period (420B), the user equipment (110) uses a random access based small data transmission or random access procedure to transmit the response message (350A) to the network node (120).

FIGS. 7-8 illustrate flowcharts depicting methods according to an example embodiment of the present disclosure. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 240 of an apparatus employing an embodiment and executed by a processor 220. As will be appreciated, any such computer program instructions may be loaded into a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded into a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In one or more embodiments, a user equipment (110) is provided, including at least one processor and at least one memory storing instructions that, when executed by the processor, cause the user equipment to receive (340), from a network node (120), paging information (340A) which contains cell discontinuous operation information (340B), wherein the paging information (340A) indicates to the user equipment (110) when to transmit a response message (350A) based on the cell discontinuous operation information. The user equipment (110) is further caused to transmit (350), to the network node (120), the response message (350A) using a small data transmission (SDT) procedure (350B) based at least on the paging information (340A).

In one or more embodiments, the paging information (340A) includes at least one of: a paging early indication, a wake-up signal, a paging DCI or a paging message.

In one or more embodiments, wherein the user equipment (110) is in a radio resource control idle mode or in a radio resource control inactive mode (330).

In one or more embodiments, the response message (350A) alternately uses at least one of: a mobile terminated small data transmission, a mobile originated small data transmission, a subsequent uplink transmission (360A), or a subsequent downlink transmission (360B).

In one or more embodiments, the cell discontinuous operation information (340B) indicates discontinuous reception (DRX) operation or discontinuous transmission (DTX) operation.

In one or more embodiments, the cell discontinuous operation information (340B) includes at least one of an active cell discontinuous operation pattern identifier (340C), a cell discontinuous operation pattern, or a cell discontinuous operation timer (410) that corresponds to a current time period (420B).

In one or more embodiments, the cell discontinuous operation timer (410) is referenced to a start time when the paging information is received or a configured reference time.

In one or more embodiments, the paging information (340A) further indicates whether to use the active cell discontinuous operation pattern identifier (340C) or the cell discontinuous operation timer (410).

In one or more embodiments, the cell discontinuous operation pattern includes at least one of a periodicity, an active period, and a starting offset.

In one or more embodiments, the cell discontinuous operation pattern is configured via system information broadcast (SIB) or radio resource control (RRC).

In one or more embodiments, the user equipment uses the cell discontinuous operation timer (410) when the cell discontinuous operation information (340B) includes the cell discontinuous operation timer (410).

In one or more embodiments, the user equipment uses the active cell discontinuous operation pattern identifier when the cell discontinuous operation information (340B) does not include the cell discontinuous operation timer (410).

In one or more embodiments, the paging information (340A) indicates an active cell discontinuous operation pattern identifier (340C) or a cell discontinuous operation pattern, the user equipment (110) transmits the response message (350A) at the beginning (390B) of a next cell discontinuous reception active period (390C) of the activated cell discontinuous operation pattern.

In one or more embodiments, when the paging information (340A) indicates a cell discontinuous operation timer (410), the user equipment (110) transmits the response message (350A) after an end (420C) of the current time period (420B).

In one or more embodiments, the paging information (340A) further indicates a time duration within which the user equipment (110) transmits the response message (350A) after the end (420C) of the current time period (420B).

In one or more embodiments, the paging information (340A) further indicates specific conditions for, prior to the end (420C) of the current time period (420B), performing random access based small data transmission or random access procedure on specific random access resources.

In one or more embodiments, when the paging information (340A) indicates a cell discontinuous operation timer (410), the user equipment (110) transmits the response message (350A) before an end (420C) of the current time period (420B).

In one or more embodiments, when a next configured grant occasion occurs after the end (420C) of the current time period (420B), the user equipment (110) uses a random access based small data transmission or random access procedure to transmit the response message (350A).

In one or more embodiments, the current time period (420B) is commonly configured for all user equipment devices in a particular cell via system information broadcast.

In one or more embodiments, the current time period (420B) is specific to the user equipment (110).

In one or more embodiments, the current time period (420B) is indicated by use of a bitmap in the paging information (340A).

In one or more embodiments, the user equipment (110) is configured to monitor first paging information not associated with a paging occasion associated with the user equipment (110) or second paging information (340A) of the paging occasion associated with the user equipment (110) for a second time period prior to initiating the subsequent uplink transmission (360A).

In one or more embodiments, if only one of an active cell discontinuous operation pattern identifier (340C) or a cell discontinuous operation timer (410) is included in the paging information (340A) the user equipment (110) applies the included active cell discontinuous operation pattern identifier (340C) or cell discontinuous operation timer (410).

In one or more embodiments, the user equipment (110) applies the cell discontinuous operation timer (410) if it is included in the paging information (340A), independently of whether the active cell discontinuous operation pattern identifier (340C) is included in the paging information (340A), wherein the user equipment (110) applies the active cell discontinuous operation pattern identifier (340C) if a cell discontinuous operation timer (410) is not included in the paging information (340A).

In one or more embodiments, the user equipment (110) applies the active cell discontinuous operation pattern identifier (340C) if it is included in the paging information (340A), independently of whether the cell discontinuous operation timer (410) is included in the paging information (340A), wherein the user equipment (110) applies the cell discontinuous operation timer (410) if an active cell discontinuous operation pattern identifier (340C) is not included in the paging information (340A).

In one or more embodiments, a network node (120) is provided, including at least one processor and at least one memory storing instructions that, when executed by the processor, cause the network node (120) to transmit (340), to a user equipment (110), paging information (340A) which contains cell discontinuous operation information (340B), wherein the paging information (340A) indicates to the user equipment (110) when to transmit a response message (350A) based on the cell discontinuous operation information. The network node (120) is further caused to receive (350), from the user equipment (110), the response message (350A) based at least on the paging information (340A).

In one or more embodiments, the paging information (340A) includes at least one of: a paging early indication, a wake-up signal, a paging DCI or a paging message.

In one or more embodiments, the user equipment (110) is in a radio resource control idle mode or in a radio resource control inactive mode (330).

In one or more embodiments, the response message (350A) alternately uses at least one of: a mobile terminated small data transmission, a mobile originated small data transmission, a subsequent uplink transmission (380A), or a subsequent downlink transmission (380B).

In one or more embodiments, the cell discontinuous operation information (340B) indicates discontinuous reception (DRX) operation or discontinuous transmission (DTX) operation.

In one or more embodiments, the cell discontinuous operation information (340B) includes at least one of an active cell discontinuous operation pattern identifier (340C), a cell discontinuous operation pattern, or a cell discontinuous operation timer (410) that corresponds to a current time period (420B).

In one or more embodiments, the cell discontinuous operation timer (410) is referenced to a start time when the paging information is received or a configured reference time.

In one or more embodiments, the paging information (340A) further indicates whether to use the active cell discontinuous operation pattern identifier (340C) or the cell discontinuous operation timer (410).

In one or more embodiments, the cell discontinuous operation pattern includes at least one of a periodicity, an active period, and a starting offset.

In one or more embodiments, the cell discontinuous operation pattern is configured via system information broadcast (SIB) or radio resource control (RRC).

In one or more embodiments, when the paging information (340) indicates an active cell discontinuous operation pattern identifier (340C) or a cell discontinuous operation pattern, the network node (120) receives the response message (350A) at the beginning (390B) of a next cell discontinuous reception active period (390C) of the activated cell discontinuous operation pattern.

In one or more embodiments, when the paging information (340A) indicates a cell discontinuous operation timer (410), the network node (120) receives the response message (350) after an end (420C) of the current time period (420B).

In one or more embodiments, the paging information (340A) further indicates a time duration within which the network node (120) receives the response message (350A) after the end (420C) of the current time period (420B).

In one or more embodiments, the paging information (340A) further indicates specific conditions for, prior to the end (420C) of the current time period (420B), performing random access based small data transmission or random access procedure on specific random access resources.

In one or more embodiments, when the paging information (340A) indicates a cell discontinuous operation timer (410), the network node (120) receives the response message (350A) before an end (420C) of the current time period (420B).

In one or more embodiments, when a next configured grant occasion occurs after the end (420C) of the current time period (420B), the user equipment (110) uses a random access based small data transmission or random access procedure to transmit the response message (350A) to the network node (120).

In one or more embodiments, the current time period (420B) is commonly configured for all user equipment devices in a particular cell via system information broadcast.

In one or more embodiments, the current time period (420B) is specific to the user equipment (110).

In one or more embodiments, the current time period (420B) is indicated by use of a bitmap in the paging information (340A).

In one or more embodiments, a computer-implemented method is provided that is performed by a user equipment (110) and includes receiving (340), from a network node (120), paging information (340A) which contains cell discontinuous operation information (340B), wherein the paging information (340A) indicates to the user equipment (110) when to transmit a response message (350A) based on the cell discontinuous operation information. The method further includes transmitting (350), to the network node (120), the response message (350A) using a small data transmission (SDT) procedure (350B) based at least on the paging information (340A).

In one or more embodiments, the paging information (340A) includes at least one of: a paging early indication, a wake-up signal, a paging DCI or a paging message.

In one or more embodiments, the user equipment (110) is in a radio resource control idle mode or in a radio resource control inactive mode (330).

In one or more embodiments, the response message (350A) alternately uses at least one of: a mobile terminated small data transmission, a mobile originated small data transmission, a subsequent uplink transmission (360A), or a subsequent downlink transmission (360B).

In one or more embodiments, the cell discontinuous operation information (340B) indicates discontinuous reception (DRX) operation or discontinuous transmission (DTX) operation.

In one or more embodiments, the cell discontinuous operation information (340B) includes at least one of an active cell discontinuous operation pattern identifier (340C), a cell discontinuous operation pattern, or a cell discontinuous operation timer (410) that corresponds to a current time period (420B).

In one or more embodiments, the cell discontinuous operation timer (410) is referenced to a start time when the paging information is received or a configured reference time.

In one or more embodiments, the paging information (340A) further indicates whether to use the active cell discontinuous operation pattern identifier (340C) or the cell discontinuous operation timer (410).

In one or more embodiments, the cell discontinuous operation pattern includes at least one of a periodicity, an active period, and a starting offset.

In one or more embodiments, the cell discontinuous operation pattern is configured via system information broadcast (SIB) or radio resource control (RRC).

In one or more embodiments, the user equipment uses the cell discontinuous operation timer (410) when the cell discontinuous operation information (340B) includes the cell discontinuous operation timer (410).

In one or more embodiments, the user equipment uses the active cell discontinuous operation pattern identifier when the cell discontinuous operation information (340B) does not include the cell discontinuous operation timer (410).

In one or more embodiments, wherein when the paging information (340A) indicates an active cell discontinuous operation pattern identifier (340C) or a cell discontinuous operation pattern, the user equipment (110) transmits the response message (350A) at the beginning (390B) of a next cell discontinuous reception active period (390C) of the activated cell discontinuous operation pattern.

In one or more embodiments, when the paging information (340A) indicates a cell discontinuous operation timer (410), the user equipment (110) transmits the response message (350A) after an end (420C) of the current time period (420B).

In one or more embodiments, the paging information (340A) further indicates a time duration within which the user equipment (110) transmits the response message (350A) after the end (420C) of the current time period (420B).

In one or more embodiments, the paging information (340A) further indicates specific conditions for, prior to the end (420C) of the current time period (420B), performing random access based small data transmission or random access procedure on specific random access resources.

In one or more embodiments, when the paging information (340A) indicates a cell discontinuous operation timer (410), the user equipment (110) transmits the response message (350A) before an end (420C) of the current time period (420B).

In one or more embodiments, when a next configured grant occasion occurs after the end (420C) of the current time period (420B), the user equipment (110) uses a random access based small data transmission or random access procedure to transmit the response message (350A).

In one or more embodiments, the current time period (420B) is commonly configured for all user equipment devices in a particular cell via system information broadcast.

In one or more embodiments, the current time period (420B) is specific to the user equipment (110).

In one or more embodiments, the current time period (420B) is indicated by use of a bitmap in the paging information (340A).

In one or more embodiments, the user equipment (110) is configured to monitor first paging information not associated with a paging occasion associated with the user equipment (110) or second paging information (340A) of the paging occasion associated with the user equipment (110) for a second time period prior to initiating the subsequent uplink transmission (360A).

In one or more embodiments, a computer implemented method is provided that is performed by a network node (120) and includes transmitting (340), to a user equipment (110), paging information (340A) which contains cell discontinuous operation information (340B), wherein the paging information (340A) indicates to the user equipment (110) when to transmit a response message (350A) based on the cell discontinuous operation information. The computer-implemented method further includes receiving (350), from the user equipment (110), the response message (350A) based at least on the paging information (340A).

In one or more embodiments, the paging information (340A) includes at least one of: a paging early indication, a wake-up signal, a paging DCI or a paging message.

In one or more embodiments, the user equipment (110) is in a radio resource control idle mode or in a radio resource control inactive mode (330).

In one or more embodiments, the response message (350A) alternately uses at least one of: a mobile terminated small data transmission, a mobile originated small data transmission, a subsequent uplink transmission (380A), or a subsequent downlink transmission (380B).

In one or more embodiments, the cell discontinuous operation information (340B) indicates discontinuous reception (DRX) operation or discontinuous transmission (DTX) operation.

In one or more embodiments, the cell discontinuous operation information (340B) includes at least one of an active cell discontinuous operation pattern identifier (340C), a cell discontinuous operation pattern, or a cell discontinuous operation timer (410) that corresponds to a current time period (420B).

In one or more embodiments, the cell discontinuous operation timer (410) is referenced to a start time when the paging information is received or a configured reference time.

In one or more embodiments, the paging information (340A) further indicates whether to use the active cell discontinuous operation pattern identifier (340C) or the cell discontinuous operation timer (410).

In one or more embodiments, the cell discontinuous operation pattern includes at least one of a periodicity, an active period, and a starting offset.

In one or more embodiments, the cell discontinuous operation pattern is configured via system information broadcast (SIB) or radio resource control (RRC).

In one or more embodiments, when the paging information (340) indicates an active cell discontinuous operation pattern identifier (340C) or a cell discontinuous operation pattern, the network node (120) receives the response message (350A) at the beginning (390B) of a next cell discontinuous reception active period (390C) of the activated cell discontinuous operation pattern.

In one or more embodiments, when the paging information (340A) indicates a cell discontinuous operation timer (410), the network node (120) receives the response message (350) after an end (420C) of the current time period (420B).

In one or more embodiments, the paging information (340A) further indicates a time duration within which the network node (120) receives the response message (350A) after the end (420C) of the current time period (420B).

In one or more embodiments, the paging information (340A) further indicates specific conditions for, prior to the end (420C) of the current time period (420B), performing random access based small data transmission or random access procedure on specific random access resources.

In one or more embodiments, when the paging information (340A) indicates a cell discontinuous operation timer (410), the network node (120) receives the response message (350A) before an end (420C) of the current time period (420B).

In one or more embodiments, when a next configured grant occasion occurs after the end (420C) of the current time period (420B), the user equipment (110) uses a random access based small data transmission or random access procedure to transmit the response message (350A) to the network node (120).

In one or more embodiments, the current time period (420B) is commonly configured for all user equipment devices in a particular cell via system information broadcast.

In one or more embodiments, the current time period (420B) is specific to the user equipment (110).

In one or more embodiments, the current time period (420B) is indicated by use of a bitmap in the paging information (340A).

In one or more embodiments, a non-transitory computer readable storage medium is provided including computer instructions that, when executed by a user equipment (110), cause the user equipment (110) to receive (340), from a network node (120), paging information (340A) which contains cell discontinuous operation information (340B), wherein the paging information (340A) indicates to the user equipment (110) when to transmit a response message (350A) based on the cell discontinuous operation information. The user equipment (110) is further caused to transmit (350), to the network node (120), the response message (350A) using a small data transmission (SDT) procedure (350B) based at least on the paging information (340A).

In one or more embodiments, a non-transitory computer readable storage medium is provided including computer instructions that, when executed by a network node (120), cause the network node (120) to transmit (340), to a user equipment (110), paging information (340A) which contains cell discontinuous operation information (340B), wherein the paging information (340A) indicates to the user equipment (110) when to transmit a response message (350A) based on the cell discontinuous operation information. The network node (120) is further caused to receive (350), from the user equipment (110), the response message (350A) based at least on the paging information (340A).

In one or more embodiments, a user equipment (110) is provided that includes means for receiving (340), from a network node (120), paging information (340A) which contains cell discontinuous operation information (340B), wherein the paging information (340A) indicates to the user equipment (110) when to transmit a response message (350A) based on the cell discontinuous operation information. The user equipment (110) further includes means for transmitting (350), to the network node (120), the response message (350A) using a small data transmission (SDT) procedure (350B) based at least on the paging information (340A).

In one or more embodiments, a network node (120) is provided that includes means for transmitting (340), to a user equipment (110), paging information (340A) which contains cell discontinuous operation information (340B), wherein the paging information (340A) indicates to the user equipment (110) when to transmit a response message (350A) based on the cell discontinuous operation information. The network node (120) further includes means for receiving (350), from the user equipment (110), the response message (350A) based at least on the paging information (340A).

Many modifications and other embodiments set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A user equipment for wireless communication, comprising:
at least one processor; and
at least one memory storing instructions that, when executed by the processor, cause the user equipment to perform:
receive, from a network node, paging information which contains cell discontinuous operation information, wherein the paging information indicates to the user equipment when to transmit a response message based on the cell discontinuous operation information; and
transmit, to the network node, the response message using a small data transmission (SDT) procedure based at least on the paging information.

2. The user equipment of claim 1, wherein the paging information comprises at least one of: a paging early indication, a wake-up signal, a paging DCI or a paging message.

3. The user equipment of claim 1, wherein the user equipment is in a radio resource control idle mode or in a radio resource control inactive mode.

4. The user equipment of claim 1, wherein the response message alternately uses at least one of: a mobile terminated small data transmission, a mobile originated small data transmission, a subsequent uplink transmission, or a subsequent downlink transmission.

5. The user equipment of claim 1, wherein the cell discontinuous operation information indicates discontinuous reception (DRX) operation or discontinuous transmission (DTX) operation.

6. The user equipment of claim 1, wherein the cell discontinuous operation information comprises at least one of an active cell discontinuous operation pattern identifier, a cell discontinuous operation pattern, or a cell discontinuous operation timer that corresponds to a current time period.

7. The user equipment of claim 6, wherein the cell discontinuous operation timer is referenced to a start time when the paging information is received or a configured reference time.

8. The user equipment of claim 6, wherein when the paging information indicates one or more of:
an active cell discontinuous operation pattern identifier or a cell discontinuous operation pattern, the user equipment transmits the response message at the beginning of a next cell discontinuous reception active period of the activated cell discontinuous operation pattern; or
a cell discontinuous operation timer, the user equipment transmits the response message after an end of the current time period or before an end of the current time period.

9. The user equipment of claim 8, wherein the paging information further indicates one or more of:
a time duration within which the user equipment transmits the response message after the end of the current time period; or
specific conditions for, prior to the end of the current time period, performing random access based small data transmission or random access procedure on specific random access resources.

10. The user equipment of claim 4, wherein the user equipment is configured to monitor first paging information not associated with a paging occasion associated with the user equipment or second paging information of the paging occasion associated with the user equipment for a second time period prior to initiating the subsequent uplink transmission.

11. The user equipment of claim 6, wherein if only one of an active cell discontinuous operation pattern identifier or a cell discontinuous operation timer is included in the paging information the user equipment applies the included active cell discontinuous operation pattern identifier or cell discontinuous operation timer.

12. The user equipment of claim 6, wherein the user equipment applies one or more of:
the cell discontinuous operation timer if it is included in the paging information, independently of whether the active cell discontinuous operation pattern identifier is included in the paging information, wherein the user equipment applies the active cell discontinuous operation pattern identifier if a cell discontinuous operation timer is not included in the paging information; or
the active cell discontinuous operation pattern identifier if it is included in the paging information, independently of whether the cell discontinuous operation timer is included in the paging information, wherein the user equipment applies the cell discontinuous operation timer if an active cell discontinuous operation pattern identifier is not included in the paging information.

13. A network node for wireless communication, comprising:
at least one processor; and
at least one memory storing instructions that, when executed by the processor, cause network node to perform:
transmit, to a user equipment, paging information which contains cell discontinuous operation information, wherein the paging information indicates to the user equipment when to transmit a response message based on the cell discontinuous operation information; and
receive, from the user equipment, the response message based at least on the paging information.

14. The network node of claim 13, wherein the paging information comprises at least one of: a paging early indication, a wake-up signal, a paging DCI or a paging message.

15. The network node of claim 13, wherein the user equipment is in a radio resource control idle mode or in a radio resource control inactive mode.

16. The network node of claim 13, wherein the response message alternately uses at least one of: a mobile terminated small data transmission, a mobile originated small data transmission, a subsequent uplink transmission, or a subsequent downlink transmission.

17. The network node of claim 13, wherein the cell discontinuous operation information indicates discontinuous reception (DRX) operation or discontinuous transmission (DTX) operation.

18. The network node of claim 13, wherein the cell discontinuous operation information comprises at least one of an active cell discontinuous operation pattern identifier, a cell discontinuous operation pattern, or a cell discontinuous operation timer that corresponds to a current time period.

19. The network node of claim 18, wherein the cell discontinuous operation timer is referenced to a start time when the paging information is received or a configured reference time.

20. The network node of claim 18, wherein when the paging information indicates one or more of:
an active cell discontinuous operation pattern identifier or a cell discontinuous operation pattern, the network node receives the response message at the beginning of a next cell discontinuous reception active period of the activated cell discontinuous operation pattern; or
a cell discontinuous operation timer, the network node receives the response message after an end of the current time period.

21. The network node of claim 20, wherein the paging information further indicates one or more of:
a time duration within which the network node receives the response message after the end of the current time period;
specific conditions for, prior to the end of the current time period, performing random access based small data transmission or random access procedure on specific random access resources; or
a cell discontinuous operation timer, the network node receives the response message before an end of the current time period.
